(19) United States
(12) Patent Application Publication
(10) Pub. No.: US 2025/0303652 A1
(43) Pub. Date: Oct. 2, 2025

(54) Tire Repair Valve System

(71) Applicant: Illinois Tool Works Inc., Glenview, IL (US)

(72) Inventors: Carey Christopher Costle, Tucson, AZ (US); Brendan Sangster, San Luis Obispo, CA (US)

(21) Appl. No.: 19/084,210

(22) Filed: Mar. 19, 2025

Related U.S. Application Data
(60) Provisional application No. 63/571,267, filed on Mar. 28, 2024.

(51) Int. Cl. B29C 73/16; B29C 73/02; B29L 30/00

(52) U.S. Cl. CPC B29C 73/166; B29C 73/025; B29L 2030/00

(57) ABSTRACT

A tire repair system for inflating or repairing a tire. The tire repair system includes a housing, a compressor to provide compressed air, a sealant delivery system to supply a mix of a tire sealant and the compressed air, and a hose to engage the tire and to deliver the tire sealant and the compressed air to the tire. The sealant delivery system includes an aerosol canister and a compressor-actuated valve assembly to automatically depress a valve stem of the aerosol canister using pressurized air from the compressor.

### RELATED APPLICATION

The present application claims priority to U.S. Provisional Patent Application No. 63/571,267, filed Mar. 28, 2024, and entitled “Tire Repair Valve System,” which is hereby incorporated by reference in its entirety.

### BACKGROUND

This present disclosure relates to a tire repair and inflation system and apparatus. For the average motorist, replacing a tire on the side of the road can be daunting and needlessly exposes the motorist to inherent roadside dangers.

One solution to an emergency flat tire repair is to use an aerosol sealant dispenser that combines a chemical fluid and a propellant. These are usually contained in a can or other type of container. A tube is attached between the can and a tire via a tire valve stem. The fluid is propelled through the tire valve stem into the tire. When the fluid flows through a tire puncture, the fluid hardens to form a repair of the tire. To enhance the seal, a compressed air source can be used to allow proper and safe inflation of the tire. An example integrated compressor-tire sealant injection device with a large mouth aerosol canister is described in commonly owned U.S. Pat. No. 6,789,581 to David Cowan et al. and U.S. Pat. No. 7,798,183 to James Cegelski and Scott Noble Hickman.

Despite existing solutions, it is desirable to provide a portable two-part system with an integrated compressor device and aerosol canister that overcomes the limitations of existing tire repair sealants, systems, and devices.

### SUMMARY

The present disclosure relates generally to a tire repair and inflation system and apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a tire repair system in accordance with an aspect of this disclosure being used to seal and/or inflate a tire.

FIGS. 2a through 2h illustrate various views of an example manually-actuated valve assembly for the tire repair system of FIG. 1.

FIGS. 2i through 2k illustrate cross-sectional views of the example manually-actuated valve assembly.

FIG. 3a illustrates a perspective view of the tire repair system with the cover removed.

FIG. 3b illustrates a cross-sectional perspective view of the tire repair system.

FIG. 3c illustrates a cross-sectional view of the example valve assembly of FIGS. 3a and 3b to show the flow of sealant and pressurized air.

FIG. 4 illustrates a cross-sectional view of an example compressor-actuated valve assembly for the tire repair system of FIG. 1.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a tire repair system with an integrated compressor device and aerosol canister for inflating or repairing a tire.

In one example, a tire repair system for inflating or repairing a tire comprises: a housing; a compressor positioned in the housing and configured to provide compressed air; an aerosol canister positioned in the housing and configured to provide a tire sealant; a hose configured to engage the tire and to deliver the tire sealant, the compressed air, or a mixture of the tire sealant and the compressed air to the tire; and a valve assembly fluidically coupled to the compressor, the aerosol canister, and the hose, wherein the valve assembly comprises an actuator configured to rotate relative to the housing about a central axis between a first position and a second position, and a depressor component configured to depress an aerosol valve stem of the aerosol canister when the valve assembly is positioned in the second position.

In some examples, the actuator comprises a lever configured to be manually engaged by a user to rotate the actuator about the central axis between the first position and the second position.

In some examples, the first position and the second are positioned 45 to 90 degrees apart about the central axis.

In some examples, the valve assembly comprises a ramp assembly configured to move the depressor component relative to the actuator when the actuator rotates about the central axis between the first position and the second position.

In some examples, the ramp assembly includes a first ramp positioned on the actuator engages a second ramp positioned on the depressor component.

In some examples, the first ramp engages the second ramp to slide the depressor component toward the aerosol valve stem when the actuator is rotated into the second position.

In some examples, the valve assembly comprises a spring configured to bias the depressor component away from the aerosol valve stem.

In some examples, the spring configured to bias the depressor component linearly along the central axis.

In some examples, the depressor component comprises one or more retention features that engage one or more corresponding retention features in the housing that restrict the depressor component to a linear movement along the central axis.

In another example, a tire repair system for inflating or repairing a tire comprises: a housing; a compressor configured to provide compressed air; a sealant delivery system configured to supply a mix of a tire sealant and the compressed air, wherein the sealant delivery system comprises an aerosol canister and a compressor-actuated valve assembly configured to automatically depress a valve stem of the aerosol canister using pressurized air from the compressor; and a hose configured to engage the tire and to deliver the tire sealant and the compressed air to the tire.

In some examples, the compressor-actuated valve assembly comprises a valve housing, a first piston, and a second piston.

In some examples, the valve housing comprises a pressurized air inlet, an outlet, and a sealant inlet.

In some examples, the valve housing further comprises a first chamber configured to house the first piston and a second chamber configured to house the second piston.

In some examples, the first piston comprises a pin configured to engage the valve stem of the aerosol canister.

In some examples, the first piston and the pin are generally cylindrical.

In some examples, the diameter of the pin is smaller than a diameter of the first piston.

In yet another example, a sealant delivery system for inflating or repairing a tire using a mix of a tire sealant from an aerosol canister and compressed air from a compressor comprises: a valve assembly configured to depress a valve stem of the aerosol canister; and a hose configured to engage the tire and to deliver the tire sealant and the compressed air to the tire, wherein the valve assembly comprises a check valve positioned between the valve stem and the hose, the check valve configured to prevent flow into the aerosol canister.

In some examples, the valve assembly comprises an actuator configured to rotate about a central axis between a first position and a second position, and a depressor component configured to depress an aerosol valve stem of the aerosol canister when the valve assembly is positioned in the second position. In some examples, the valve assembly comprises a ramp assembly configured to move the depressor component relative to the actuator when the actuator rotates about a central axis between the first position and the second position. In some examples, the ramp assembly includes a first ramp positioned on the actuator that is configured to engage a second ramp positioned on the depressor component, wherein the first ramp and the second ramp cooperate to slide the depressor component toward the aerosol valve stem when the actuator is rotated into the second position.

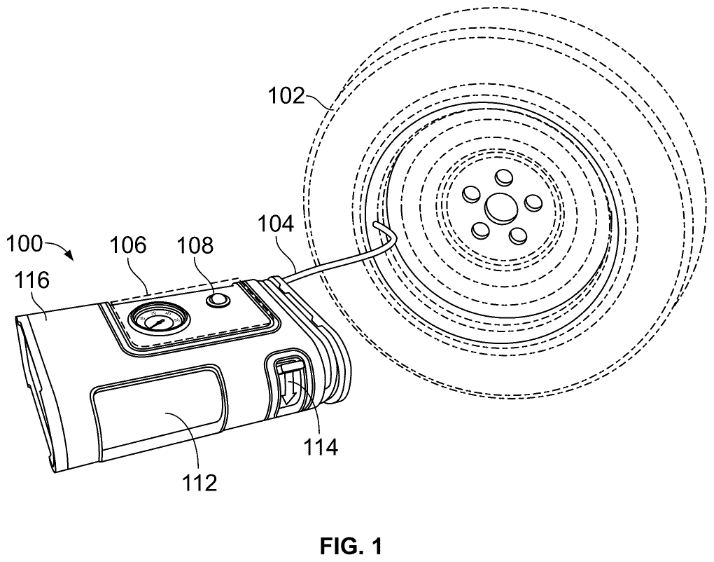

FIG. 1 illustrates a tire repair system 100 in accordance with an aspect of this disclosure being used to seal and/or inflate a tire 102, such as a vehicle tire. In the illustrated example, the tire repair system 100 may be coupled to the tire 102 via a hose 104. As will be discussed, the hose 104 may inject compressed fluid (e.g., gas or air) and a sealant from an aerosol canister 112 into the tire 102 in order to both repair and re-inflate the tire 102. In some examples, the tire repair system 100 may be used, selectively, in a first mode of operation in which both compressed air and sealant are injected into the tire 102 or a second mode of operation in which only compressed air from the compressor is injected into the tire 102. The tire repair system 100 may use virtually any type of sealant (e.g., emergency tire sealant) including, for example, Fix-A-Flat™ and/or Slime™ brand sealants.

As illustrated, the various components of the tire repair system 100 are positioned in and/or integrated with a housing 116. The housing 116, or components thereof, may be fabricated from a plastic material, such as acrylonitrile butadiene styrene (ABS), polypropylene (PP), polyethylene terephthalate (PET), high-density polyethylene (HDPE), polyvinyl chloride (PVC), low-density polyethylene (LDPE), polystyrene (PS), or a combination thereof. In some examples, one or more components are transparent (e.g., clear, translucent, etc.). The housing 116 generally houses an inflation system having a compressor 106 and a sealant delivery system having an aerosol canister 112 that works in concert to inflate and/or repair the tire 102 (e.g., a punctured automobile tire) via, for example, a manual or automated valve assembly. The sealant is propelled from the aerosol canister 112 into the inflatable tire 102 in order to repair a puncture in the tire 102.

The tire repair system 100 may further include one or more controls, such as a start button 108, in or on the housing 116, that controls the operation of the tire repair system 100. In some examples, the tire repair system 100 repairs the tire 102 and fully inflates the tire 102 using the inflation system and the sealant delivery system via a press of the start button 108. Certain components of the inflation system may be positioned within the housing 116 or behind a portion of the housing 116 (e.g., a sub panel, cover, etc.) to, for example, improve aesthetics and/or to provide a surface upon which instructions may be provided.

The illustrated inflation system generally comprises a compressor 106, a gauge 110, the start button 108, and one or more conduits that fluidically couple with a valve assembly 114 of the sealant delivery system to facilitate controlled release of sealant from the aerosol canister 112. The compressor 106 can couple electrically to the vehicle via an electrical plug and cable to derive the power needed to operate the tire repair system 100. The compressor 106 can be a small 12V DC gear-driven, piston-type compressor. Additionally, or alternatively, a rechargeable battery pack can be integrated with the housing 116 to power the various components, such as the compressor 106. The rechargeable battery pack may be a rechargeable lithium battery for outputting a direct current (DC) voltage.

The compressor 106 is configured to cooperate with the aerosol canister 112 to provide a mixture of compressed air and tire sealant to the tire 102 via the hose 104 and one or more hose attachments. The hose attachment may include a screw valve that connects to the tire 102 (e.g., via a tire valve stem of the tire 102). The screw valve of the hose attachment opens when attached to the tire 102 and closes when disconnected from the tire 102 to prevent spray and dripping of compressed air and the sealant fluid.

In the illustrated example, compressed air from the compressor 106 is first passed through the sealant delivery system where it mixes with tire sealant from the aerosol canister 112 prior to delivery to the tire 102. The gauge 110 is configured to display the status of the tire repair system 100 and/or the pressure in the tire 102, usually measured in pounds per square inch (psi). The gauge 110 provides, for example, the pressure of the tire 102 so that the user of the device can inflate the tire 102 to the proper pressure as over-inflation and/or under-inflation are detrimental to the tire 102.

The illustrated sealant delivery system generally comprises the aerosol canister 112 and a valve assembly 114. The aerosol canister 112 is configured to house a volume of tire sealant.

The aerosol canister 112 typically comprises a can body, aerosol valve assembly, aerosol actuator, dip tube (in some instances), tire sealant, and propellant. The can body of the aerosol canister 112 serves as the primary container, typically made from metal such as aluminum or steel, although plastic variants are also utilized. Its primary function is to securely contain the contents of the aerosol canister 112.

The aerosol valve assembly acts as the mechanism that controls the release of the contents from the aerosol can body. An aerosol valve assembly can include an aerosol valve stem 232, gasket, and spring. When the aerosol valve stem 232 is depressed, it opens the aerosol valve assembly, enabling the release of the tire sealant. The aerosol actuator, usually made of plastic, is the component pressed down via a user or a depressor component of the valve assembly 114 to activate the aerosol canister 112. The aerosol actuator is affixed to the aerosol valve stem 232 and may be configured to engage the valve assembly of the tire repair system 100 (e.g., via threading). Where applicable, a dip tube extends from the aerosol valve assembly into the can body, facilitating the upward movement of the product when the valve is engaged. Aerosol products commonly include a propellant, a gas aiding in propelling the tire sealant out of the can upon valve activation. Common propellants comprise compressed air, nitrogen, carbon dioxide, or hydrocarbons such as propane or butane. In some examples, the aerosol canister 112 may store 20 ounces or more of emergency tire sealant; thought smaller volumes can be employed for other applications. In one example, the aerosol canister 112 may store 14 to 18 ounces of emergency tire sealant.

The aerosol canister 112 may be removably coupled to the tire repair system 100 via the valve assembly 114 to allow for the aerosol canister 112 to be replaced once depleted. The aerosol canister 112 is fluidically coupled to the hose 104 via the valve assembly 114 to allow for the tire sealant to mix with the compressed air from the inflation system prior to delivery to the tire via the hose 104 and the hose attachment. That is, the valve assembly 114 is configured to couple the aerosol canister 112 to the sealant delivery system so that sealant may be injected into the tire 102 with the compressor air and the valve assembly 114 that couples the aerosol canister 112 to the tire repair system 100.

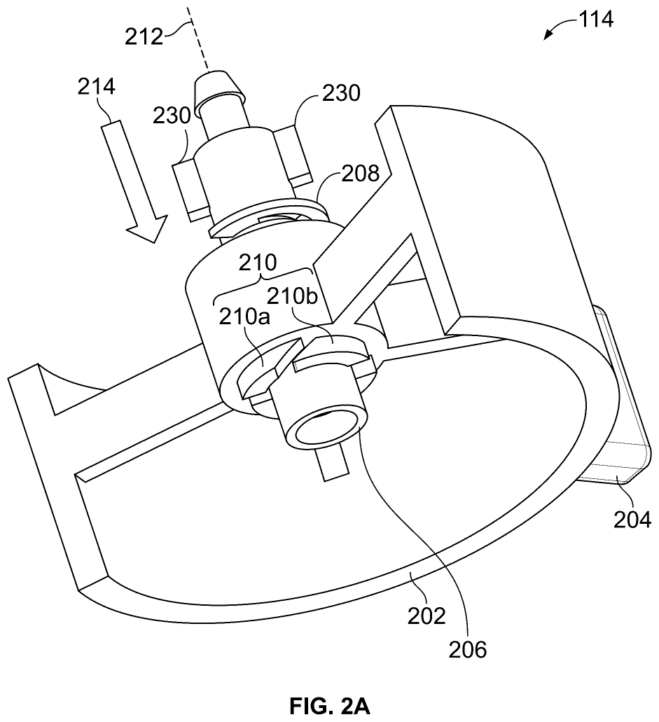

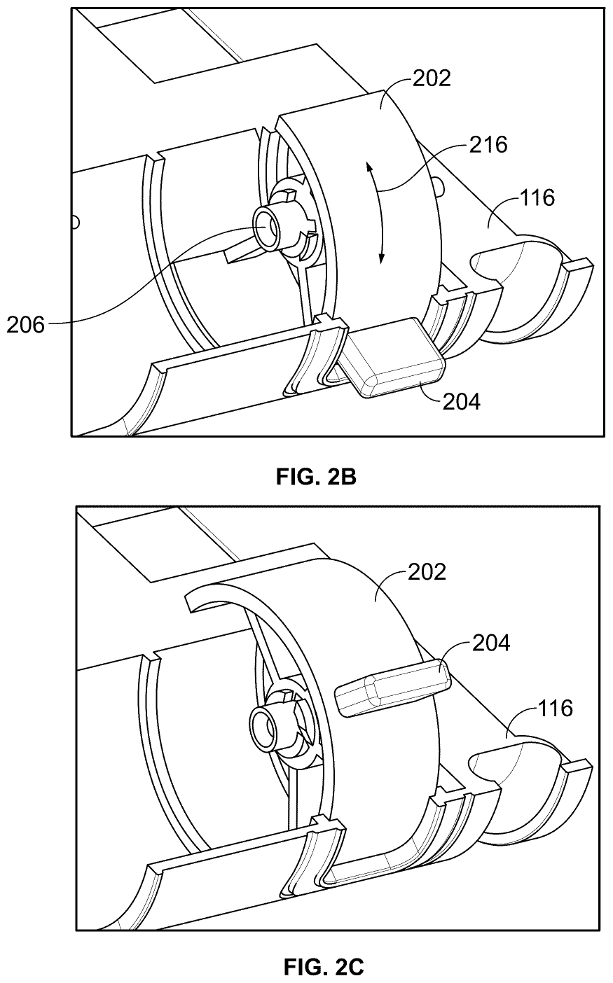

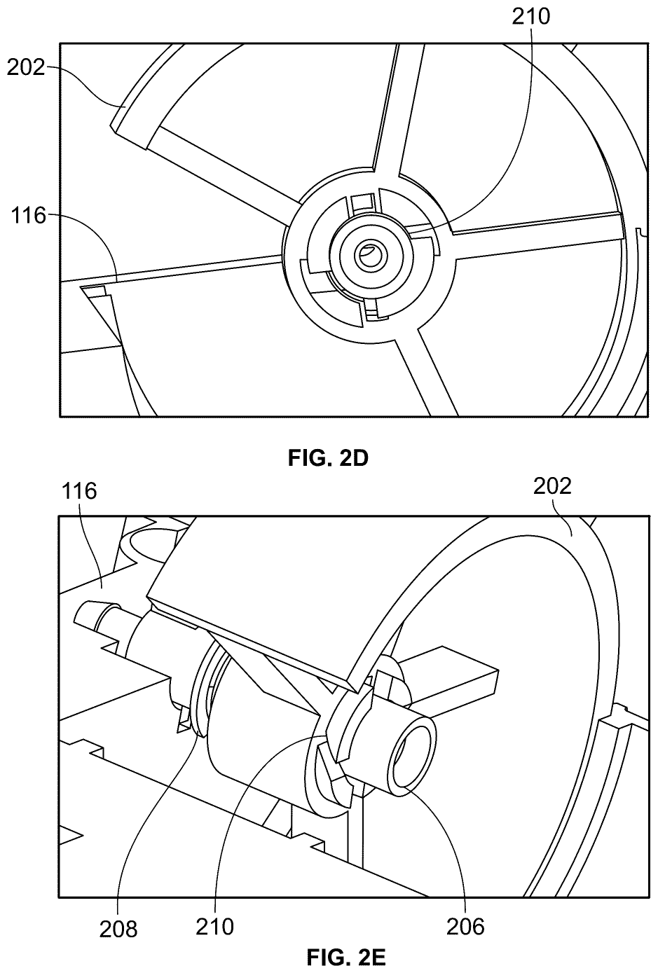

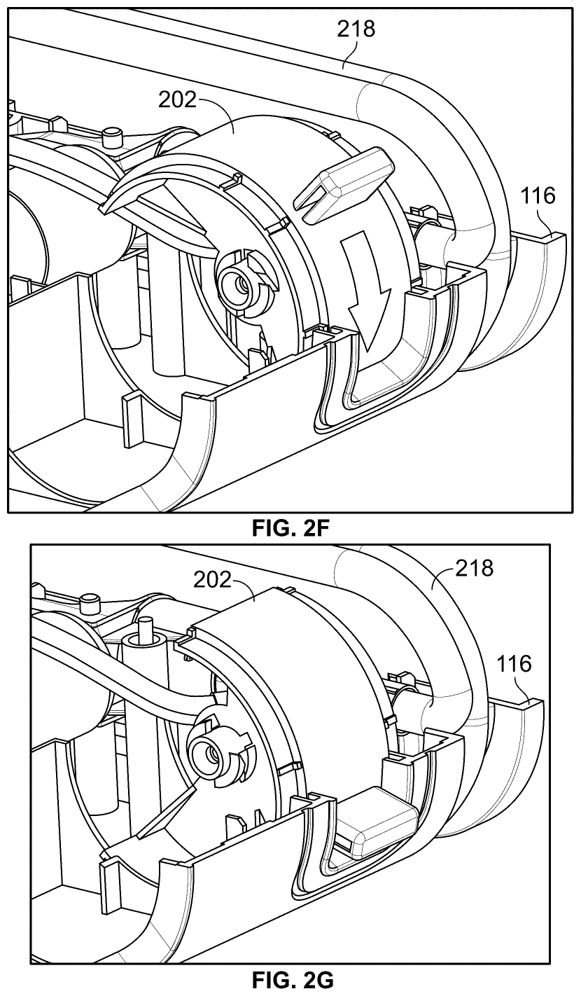

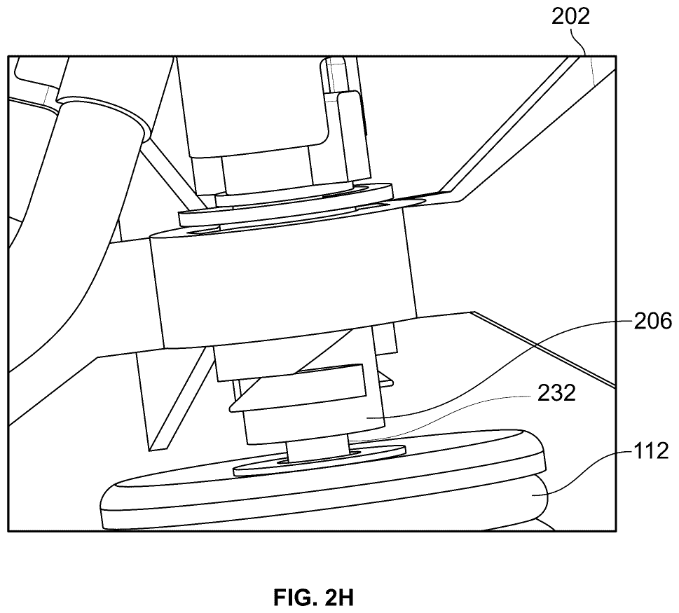

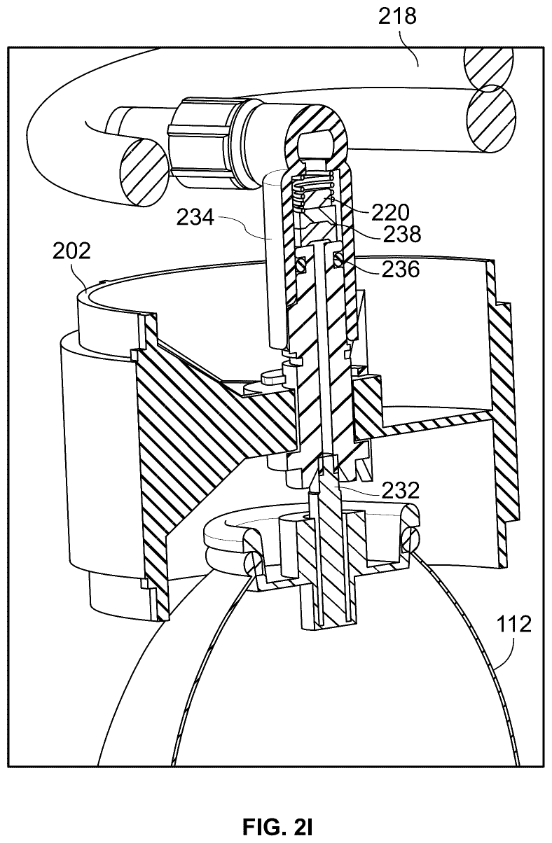

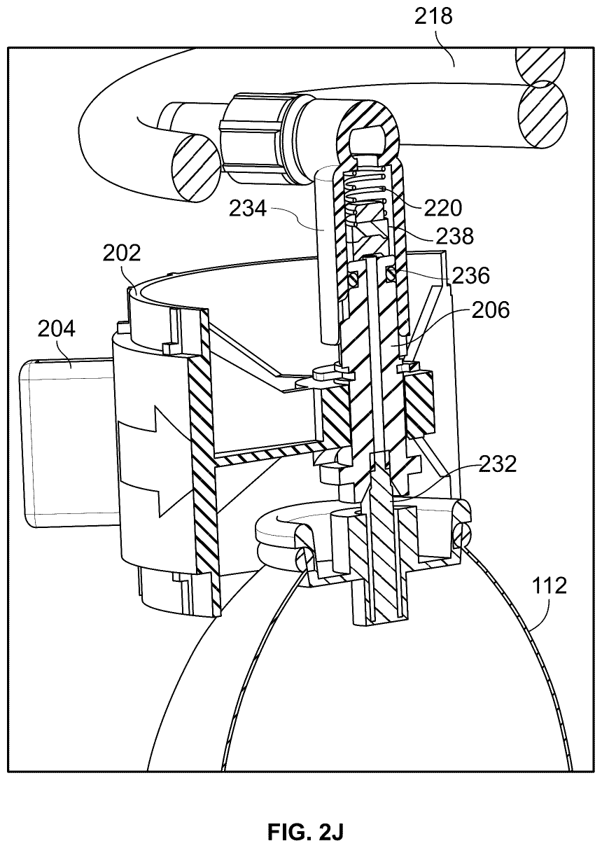

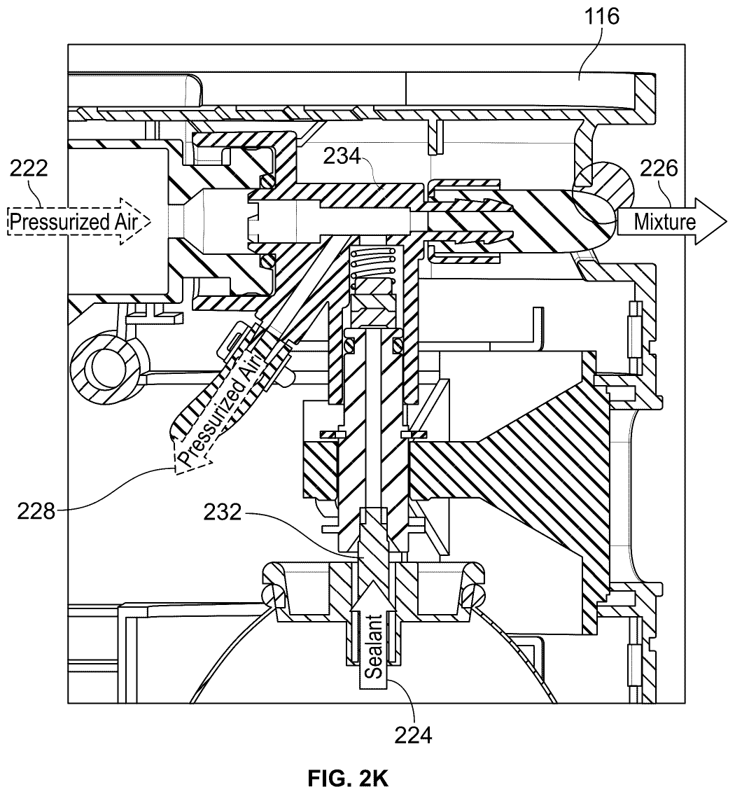

FIGS. 2a through 2h illustrate various views of an example manually-actuated valve assembly 114 for the tire repair system of FIG. 1, while FIGS. 2i through 2k illustrate cross-sectional views of the example manually-actuated valve assembly 114 where FIG. 2k illustrates a cross-sectional view of the example compressor-actuated valve assembly 114 to show the flow of sealant and pressurized air.

The valve assembly 114 can include an actuator 202 and a depressor component 206. The depressor component 206 is configured to translate linearly within a valve chamber 238 defined via a valve housing 234. In some examples, as best illustrated in FIG. 2k, the valve housing 234 is configured as a T-connector with three inlets or outlets, in this case, a pressurized air inlet, a sealant inlet, and an outlet to out mixture of sealant and/or pressurized air. To facilitate connection with a hose 104, tubing 218, or otherwise, the pressurized air inlet and the outlet can include, for example, barb fittings, threaded fittings, etc. The sealant inlet, in this case, defines the valve chamber 238 configured to slidably receive the depressor component 206. One or more seals 236 (e.g., O-rings) can be positioned about the depressor component 206 to form a seal with the inner wall of the valve chamber 238.

In use, the actuator 202 can be rotated (e.g., about 45 to 90 degrees, or about 60 degrees) within housing 116 via a lever 204 about a central axis 212. In some examples, the lever 204 is integrally-formed with the actuator 202 (e.g., molded or otherwise formed as a single component). The lever 204 is configured to be manually engaged by the user to move the actuator 202 between a first position (e.g., a rest position) and a second position (e.g., an active position). In the rest position (e.g., “off,” no-flow position), the depressor component 206 does not depress the aerosol valve stem 232 of the aerosol canister 112.

Once the actuator 202 is rotated from the rest position to the active position (e.g., to an “on,” flow position) as indicated by arrow 216, a ramp assembly 210 having a first ramp 210a on the actuator 202 engages a second ramp 210b on the depressor component 206 to slide the depressor component 206 relative to the valve chamber 238 vertically along the central axis 212 toward the aerosol valve stem 232 of the aerosol canister 112, as indicated by arrow 214. Depressing the aerosol valve stem 232 of the aerosol canister 112 serves to open the aerosol valve assembly, allowing sealant/propellant flow from the aerosol canister 112 to the hose 104 via tubing 218. The depressor component 206 can be biased via a spring 220 to enable the depressor component 206 to return to a default position along the central axis 212.

The depressor component 206 comprises one or more retention features 230 that align with corresponding retention features in the main housing 116 and/or the valve chamber 238, allowing the depressor component 206 to move linearly along the central axis 212, as indicated by arrow 214, but not rotate within the valve chamber 238 about the central axis 212. In this example, the depressor component 206 is limited to one degree of freedom—linear movement along the central axis 212. In the illustrated example, the one or more retention features 230 are configured as fins or blades (e.g., generally flat protrusions), while the corresponding retention features in the main housing 116 can be provided as slots or recesses sized and shaped to receive the one or more retention features 230. It is contemplated, however, that the inverse is possible, where fins or blades are provided in or on the main housing 116 and/or valve chamber 238 and the slots or recesses are formed in or on the depressor component 206.

A clip 208 (e.g., a C-clip) can be installed to limit the travel of the depressor component 206. With reference to FIG. 2h, arrow 222 represents airflow of pressurized air from compressor 106, arrow 226 represents mixed flow (e.g., a mixture of sealant and pressurized air) to the tire 102, arrow 224 represents the flow of sealant/propellant through the valve assembly 114 when actuated, and arrow 228 represents airflow of pressurized air to the gauge 110.

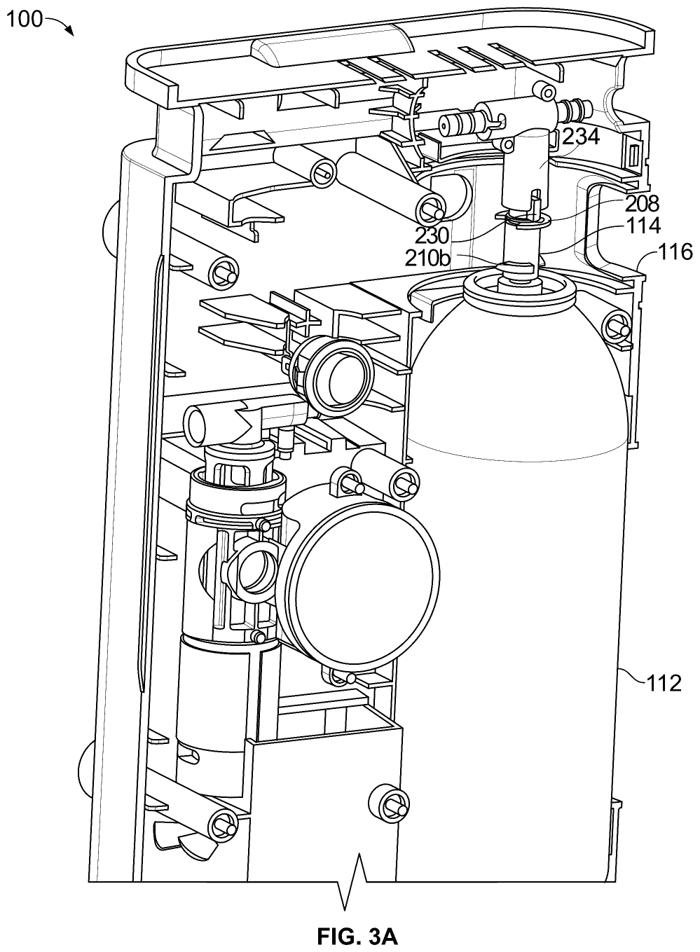

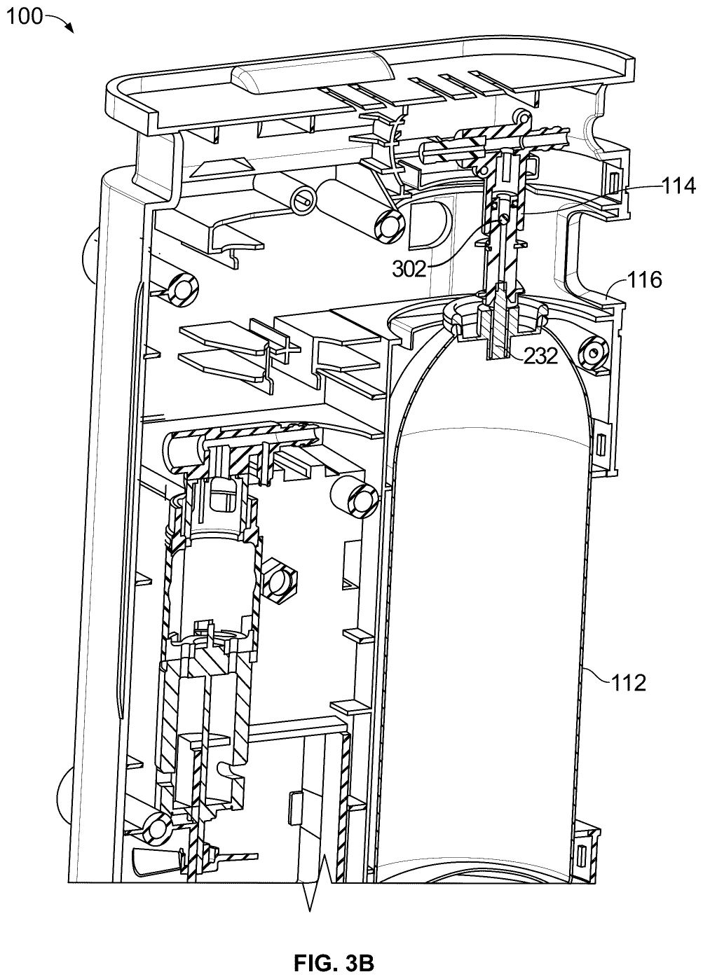

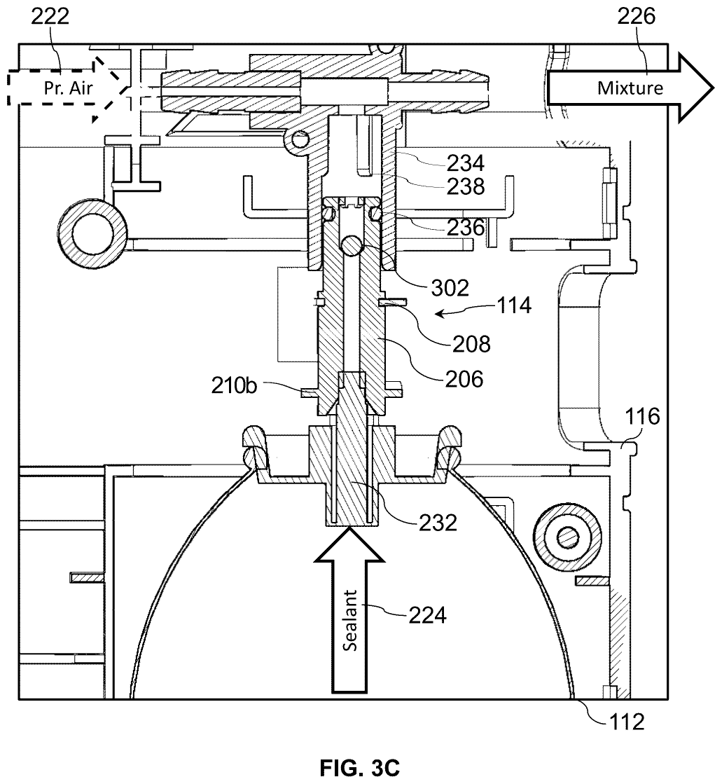

FIGS. 3a through 3c illustrate another example of a manually-actuated valve assembly for the tire repair system of FIG. 1, in accordance with another aspect. Specifically, FIG. 3a illustrates a perspective view of the tire repair system 100 with the cover, the actuator 202, and various tubing omitted for illustrative purposes, while FIG. 3b illustrates a cross-sectional perspective view of the tire repair system 100. FIG. 3c further details a cross-sectional view of the example valve assembly 114 from FIGS. 3a and 3b, illustrating the flow of sealant 224 and pressurized air 222. The manually-actuated valve assembly of FIGS. 3a through 3c is similar in terms of basic structure and operation to the manually-actuated valve assembly of FIGS. 2a through 2k.

In this example, one or more check valves 302 are incorporated to prevent backflow and ensure proper directional flow within the tire repair system 100. For instance, check valves can be provided to prevent backflow into both the compressor 106 and the aerosol canister 112. By way of example, the check valve 302 can be a ball check valve or a diaphragm check valve positioned within the manually-actuated valve assembly 114 to prevent backflow into the aerosol canister 112, thereby maintaining proper sealant and air separation. Similarly, another check valve can be a one-way spring-loaded disc check valve, or a reed valve can be integrated with the compressor 106 to block backflow, ensuring that pressurized air moves only toward the intended pathway (e.g., the air inlet to the valve housing 234).

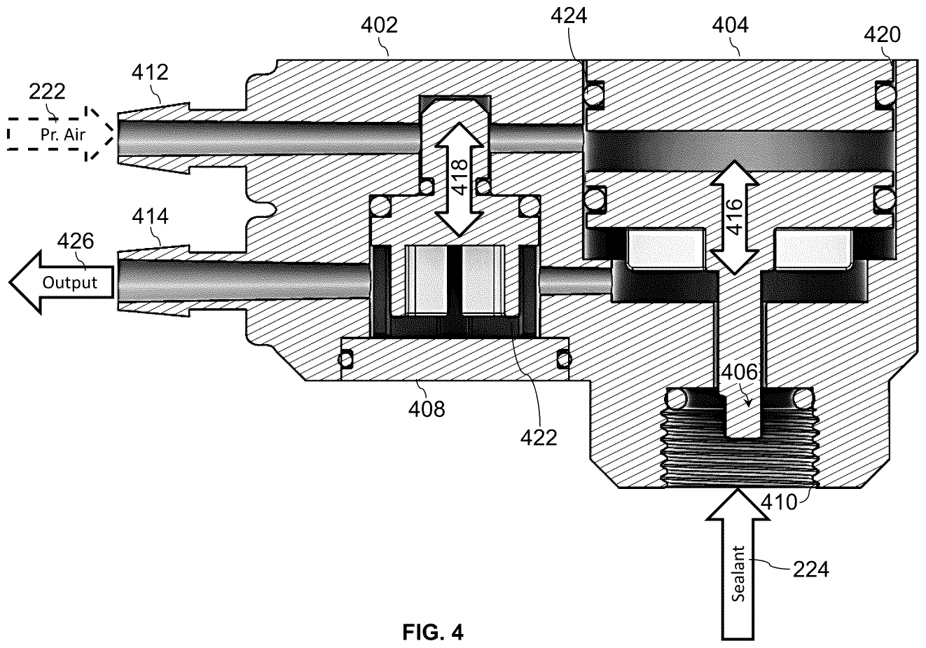

FIG. 4 illustrates a cross-sectional view of an example compressor-actuated valve assembly 114 for the tire repair system depicted in FIG. 1. In this scenario, rather than employing a lever 204 to manually rotate an actuator 202, the aerosol valve stem 232 of the aerosol canister 112 can be automatically depressed using pressurized air (or another gas) from the compressor 106.

The illustrated compressor-actuated valve assembly 114 generally comprises a valve housing 402, a first piston 404, and a second piston 408. The valve housing 402 comprises or defines one or more features to engage other components of the tire repair system 100. For instance, the illustrated valve housing 402 defines a pressurized air inlet 412, an outlet 414, and a sealant inlet 410. The illustrated valve housing 402 further defines a first chamber 420 and a second chamber 422 to house, respectively, the first piston 404 and the second piston 408.

As illustrated, the first piston 404 comprises or defines a pin 406 configured to engage the aerosol valve stem 232 of the aerosol canister 112. In some examples, the first piston 404 and the pin 406 are generally cylindrical and generally concentric with one another, but the diameter of the pin 406 in the illustrated example is smaller than the diameter of the first piston 404 (e.g., the main body of the first piston 404). Other shapes and configurations, however, are contemplated.

Each of the first piston 404 and the second piston 408 is configured to move within a chamber formed in the valve housing 402 (e.g., the first chamber 420 and the second chamber 422) in a linear motion relative to the valve housing 402 between two positions (e.g., an open/closed or up/down position as indicated by arrows 416, 418) to selectively control the flow of fluid through the compressor-actuated valve assembly 114, whether pressurized air, sealant, or a mixture thereof. Each of the first piston 404 and the second piston 408 may include one or more seals 424 (e.g., an annular ring) to maintain a seal between the first piston 404 and the second piston 408 and the walls of their respective first chamber 420 or second chamber 422.

The pressurized air inlet 412 is configured to fluidically couple with the compressor 106 to receive pressurized air from the compressor 106, as indicated by arrow 222. The outlet 414 is configured to fluidically couple with the hose 104 (whether directly or via intermediate tubing 218) to ultimately provide a mixed flow (e.g., a mixture of sealant and pressurized air) to the tire 102, as indicated by arrow 426. The sealant inlet 410, which can be in the form of a threaded cavity or opening, is configured to threadedly engage (whether directly or indirectly) a portion of the aerosol canister 112 to actuate the aerosol valve stem 232 of the aerosol canister 112, for example.

Upon application of pressurized air to the pressurized air inlet 412, the first piston 404 moves down (toward the aerosol canister 112) to activate the aerosol canister 112 via the pin 406. Upon activation of the aerosol canister 112 via the pin 406, sealant flows into the valve housing 402 via the sealant inlet 410. The second piston 408 will move as indicated by arrow 418 and open the air path once sealant/propellant is dispensed and can pressure is no longer present. The sealant then flows through this chamber 422 to the tire 102. The pressure from the aerosol canister 112 keeps the second piston 408 pushed up (pressure differential) until the aerosol canister 112 is empty. That is, pressure trapped in the first chamber 420 (about 60 PSI) via the second piston 408 maintains the first piston 404 against the aerosol canister 112 until the aerosol canister 112 is depleted.

In the illustrated example of FIG. 4, the output 426 is the sealant (and any propellant) from the aerosol canister 112, which is later mixed with pressurized air externally to the valve housing 402 and delivered to the tire 102. In other examples, however, the sealant can be mixed with pressurized air prior to exiting the valve housing 402.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A tire repair system for inflating or repairing a tire, the tire repair system comprising:
a housing;
a compressor positioned in the housing and configured to provide compressed air;
an aerosol canister positioned in the housing and configured to provide a tire sealant;
a hose configured to engage the tire and to deliver the tire sealant, the compressed air, or a mixture of the tire sealant and the compressed air to the tire; and
a valve assembly fluidically coupled to the compressor, the aerosol canister, and the hose,
wherein the valve assembly comprises an actuator configured to rotate relative to the housing about a central axis between a first position and a second position, and a depressor component configured to depress an aerosol valve stem of the aerosol canister when the valve assembly is positioned in the second position.

2. The tire repair system of claim 1, wherein the actuator comprises a lever configured to be manually engaged by a user to rotate the actuator about the central axis between the first position and the second position.

3. The tire repair system of claim 1, wherein the first position and the second are positioned 45 to 90 degrees apart about the central axis.

4. The tire repair system of claim 1, wherein the valve assembly comprises a ramp assembly configured to move the depressor component relative to the actuator when the actuator rotates about the central axis between the first position and the second position.

5. The tire repair system of claim 4, wherein the ramp assembly includes a first ramp positioned on the actuator engages a second ramp positioned on the depressor component.

6. The tire repair system of claim 5, wherein the first ramp engages the second ramp to slide the depressor component toward the aerosol valve stem when the actuator is rotated into the second position.

7. The tire repair system of claim 1, wherein the valve assembly comprises a spring configured to bias the depressor component away from the aerosol valve stem.

8. The tire repair system of claim 7, wherein the spring configured to bias the depressor component linearly along the central axis.

9. The tire repair system of claim 1, wherein the depressor component comprises one or more retention features that engage one or more corresponding retention features in the housing that restricts the depressor component to a linear movement along the central axis.

10. A tire repair system for inflating or repairing a tire, the tire repair system comprising:
a housing;
a compressor configured to provide compressed air;
a sealant delivery system configured to supply a mix of a tire sealant and the compressed air,
wherein the sealant delivery system comprises an aerosol canister and a compressor-actuated valve assembly configured to automatically depress a valve stem of the aerosol canister using pressurized air from the compressor; and
a hose configured to engage the tire and to deliver the tire sealant and the compressed air to the tire.

11. The tire repair system of claim 10, wherein the compressor-actuated valve assembly comprises a valve housing, a first piston, and a second piston.

12. The tire repair system of claim 11, wherein the valve housing comprises a pressurized air inlet, an outlet, and a sealant inlet.

13. The tire repair system of claim 12, wherein the valve housing further comprises a first chamber configured to house the first piston, and a second chamber configured to house the second piston.

14. The tire repair system of claim 11, wherein the first piston comprises a pin configured to engage the valve stem of the aerosol canister.

15. The tire repair system of claim 14, wherein the first piston and the pin are generally cylindrical.

16. The tire repair system of claim 14, wherein a diameter of the pin is smaller than a diameter of the first piston.

17. A sealant delivery system for inflating or repairing a tire using a mix of a tire sealant from an aerosol canister and compressed air from a compressor, the sealant delivery system comprising:
a valve assembly configured to depress a valve stem of the aerosol canister; and
a hose configured to engage the tire and to deliver the tire sealant and the compressed air to the tire,
wherein the valve assembly comprises a check valve positioned between the valve stem and the hose; the check valve configured to prevent flow into the aerosol canister.

18. The sealant delivery system of claim 17, wherein the valve assembly comprises an actuator configured to rotate about a central axis between a first position and a second position, and a depressor component configured to depress an aerosol valve stem of the aerosol canister when the valve assembly is positioned in the second position.

19. The sealant delivery system of claim 18, wherein the valve assembly comprises a ramp assembly configured to move the depressor component relative to the actuator when the actuator rotates about a central axis between the first position and the second position.

20. The sealant delivery system of claim 19, wherein the ramp assembly includes a first ramp positioned on the actuator that is configured to engage a second ramp positioned on the depressor component, wherein the first ramp and the second ramp cooperate to slide the depressor component toward the aerosol valve stem when the actuator is rotated into the second position.
